(19) United States
(12) Patent Application Publication
(10) Pub. No.: US 2015/0066579 A1
(43) Pub. Date: Mar. 5, 2015

(54) Method of and Apparatus for Determining Worth of a Displayed Component

(71) Applicant: Middleton Technology Limited, London (GB)

(72) Inventors: Timothy Andre William George de Paris, London (GB); Benjamin Lewis Harris, London (GB)

(21) Appl. No.: 14/012,763

(22) Filed: Aug. 28, 2013

(30) Foreign Application Priority Data
Aug. 28, 2013 (GB) 1215295.5

(51) Int. Cl. G06Q 30/02

(52) U.S. Cl. CPC G06Q 30/0201
USPC 705/7.29

(57) ABSTRACT

A method comprising determining a value indicative of worth of a component. The component is configured for display in an online browsing window. The determining is in dependence at least on the occurrence of a predetermined at least one user interaction relating to the component and a predefined event following the predetermined at least one user interaction. The predetermined at least one user interaction may comprise a predetermined sequence of user interactions. The the component may occupy one of plurality of possible positions in the online browsing window. The value may be determined in dependence on the potential value or actual value of the event.

### FIELD OF THE INVENTION

The present invention relates to a method comprising determining a value indicative of worth of a component. The invention also relates to apparatus for determining a value indicative of worth of a component, and to a related computer program product.

### BACKGROUND OF THE INVENTION

Web pages are typically stored on a web server and remotely accessed by a user at a client computer over the Internet using a web browser. A web site is a collection of web pages. Distinct websites may be respectively identified by associated unique Internet domain names. A web page can link to another web page on the same web site or a different web site using hyperlinks. Such links allow a user to browse a website or linked websites by selecting the links between the web pages.

Web pages often include hyperlinks to third party websites; web pages may include objects that link to third party web sites. Programs for analysing web traffic to monitor traffic to third party web sites from a particular web page or website are known. Typically, such a program runs on the web server that is being monitored. Logs can be generated comprising information about web server activity, for example number of visits to a website. An assessment of the usefulness of the component on a particular web page in directing users to another web page can be made from such monitoring. Alternatively, websites use client side script, such as javascript, to monitor traffic. Such script can collect information and submit it to the server where the information is analysed and stored.

The value of links can be difficult to assess, since the value does not always simply depend on generation of traffic to a linked web page.

Further, it is a problem for a website owner to determine whether a website, or a particular web page, is arranged in the optimal way to facilitate users that are valuable on another web page accessing that web page.

It is an object of the present invention to aid in understanding the value of a component on a webpage, and of what content, layout, areas of a web page or web site, or other variables, lead to that web page or web site having high value.

### SUMMARY OF THE INVENTION

According to an aspect of the present invention, there is provided a method comprising determining a value indicative of worth of a component, wherein the component is configured for display in an online window, in dependence at least on the occurrence of a predetermined at least one user interaction relating to the component and a predefined event following the predetermined at least one user interaction.

Thus, information about the interaction or series of interactions by a user upon the individual components of a web page may be collected by an analytics system. The system may analyse user activity information on the interaction or series of interactions performed by users upon a web page to determine whether that interaction or series of interactions resulted in a desired behaviour, that is, in an event or a “conversion”.

Thus, the method may be used in calculating the value of components of a web property (web site, web page, extranet or other content delivered through a web browser of web-enabled device).

The method may comprise a prior step of segmenting website visitors into those that performed interactions leading to a desired conversion (herein referred to as “valuable visitors”) and those that did not.

The predetermined at least one user interaction may comprise a predetermined sequence of user interactions. The method may also further comprise displaying information representative of the value.

The component may occupy one of plurality of possible positions in the online browsing window.

The value may be determined in dependence on the potential value or actual value of the event. The event may be one of: selecting a further predetermined component; completing and submitting an online form; registering for a service; purchasing a particular product or service online; purchasing a product or service from a particular website (optionally a third party website); submitting a response to at least one question; placing a voice call to a predetermined number. The method may comprise determining the value provided by the custom of a valuable visitor, whether that value constitutes the potential of a future conversion (herein known as “potential value”) or the actual monetary or non-monetary value of the custom (herein known as “actual value”).

An event value may be associated with a particular event, in which case the value indicative of worth is also determined in dependence on said event value. For example, where the event is a sale or potential sale, the event value may be the value of the product or service purchased or to be purchased. Alternatively, an event value may be associated with the completing and submission of a form.

The method may comprise determining a value for each of at least two components contemporaneously displayed in different positions in the online browsing window, and causing information representative of the value for each component to be graphically displayed in a heat map. The heat map may have a plurality of areas, wherein each area corresponds to a respective one of the components and in each area the determined value for each component is graphically represented. The area of the heat map corresponding to a one of the components may be approximately of the same size on the display as the area occupied by the one component and may be in approximately the same position as the one component. The heat map may be caused to display to translucently overlie the webpage to provide a graphic representation of the worth of the components on the web page. The heat map may be generated by heat map code executable to send a request for information on the value, e.g. the values, for particular components during a session to the analytics system, and to receive said information.

A web page or website may be adaptive or build using responsive web design. In either case, the web page, that is the layout and/or structure and/or content thereof, may be adapted dependent on characteristics of a client device. In this case, where a heat map is to be rendered by the device, the rendering is preferably performed so that the areas of the rendered heat map each corresponds to a respective one of the components and in each area the determined value for each component is graphically represented. The area of the heat map corresponding to a one of the components may be approximately of the same size on the display as the area occupied by the one component and may be in approximately the same position as the one component.

The web page may be dynamic, the method comprising dynamically positioning the visual representation of the worth of the components to overlie the corresponding component.

The causing to display a heat map may comprise determining a color from a predefined list of colors, wherein the colors correspond to values of the worth of the at least two components. The method may include producing a visual heatmap that indicates value at the position and layout of the elements for which interaction data and value is displayed.

The method may further comprise capturing and storing data indicative of the occurrence of the predetermined at least one user interaction and the event that follows the predetermined at least one user interaction, to enable determining of the value.

The determining the value may also be performed in dependence on at least one piece of information received and stored by processing apparatus, the at least one piece of information relating to attributes of the user, user device, user behaviour and/or user interactions in the online browser window.

The method may also include determining the value of each individual component of web pages within a web site by attributing the individual potential and actual values of valuable visitors to the components of the web pages with which they interacted during their visit, and collating these individual values to determine the collective value of each component of individual web pages.

The method may further comprise, each time said data is captured and stored, also receiving and recording in the store at least one of the following pieces of information in association with the data: data indicative of at least one attribute of the system environment of the device on which the web page is accessed; at least one attribute of the user of the device; data indicative of scrolls over the component; data indicative of the length of visit on the webpage; information on component visibility; information on content, layout, colors, calls to action displayed (i.e. information on requests for the user to perform to perform a particular act or action) to user; information on component interaction; an URL of the web page; title; taxonomy of the website and web page; an identifier of the browser used to access the web page; an identifier of a referrer; an identifier of a non-computer language(s) used in the website.

The at least one component may be part of a webpage or website or a plurality of webpages or plurality of websites. The at least one component may be produced from front end code, for example an HTML element.

The method may further comprise: determining a value for a component in accordance with the method described above; rearranging the position of the component in the window or modifying the component; determining a value for the rearranged or modified component as described above; displaying the component or the rearranged or modified component in dependence on which is higher of the values.

The method may further comprise, prior to the step of displaying, comparing, by the processing apparatus, the values, wherein the display of the component or the rearranged or modified component is done based on a result of the comparison. The rearranging or modifying may be performed automatically by the processing apparatus.

According to a second aspect of the present invention, there may be provided a computer program product stored on a computer readable storage medium and comprising executable instructions, which, when executed by processing apparatus, causes determining of a value indicative of worth of a component, wherein the component is configured for display in an online browsing window, in dependence at least on the occurrence of a predetermined at least one user interaction relating to the component and a predefined event following the predetermined at least one user interaction.

According to a third aspect of the present invention, there may be provided at least one processor; at least one memory including computer program code, the at least one memory and the computer program code, with the at least one processor, being configured to cause the apparatus at least to perform determining of a value indicative of worth of a component, wherein the component is configured for display in an online browsing window, in dependence at least on the occurrence of a predetermined at least one user interaction relating to the component and a predefined event following the predetermined at least one user interaction.

### BRIEF DESCRIPTION OF DRAWINGS

Embodiments of the present invention will now be described, by way of example only, with reference to the accompanying drawings in which:

FIG. 1 is a network diagram of basic elements in a system with which embodiments of the present invention may be performed;

FIG. 2 shows an exemplary webpage upon which a value heat map has been displayed overlying certain components;

FIG. 3 shows the webpage of FIG. 2, with additional display of data relating to a selected component of the webpage upon which the value heat map has been displayed;

FIGS. 4A and 4B show webpages with the same components as the webpage shown in FIG. 2 and a value heat map displayed upon the components, but with the components repositioned,

### DETAILED DESCRIPTION OF DRAWINGS

Embodiments of the present invention are directed to a method comprising determining a value indicative of worth of a component, for example an HTML element, displayed in an online browsing window.

The value is determined in dependence at least on the occurrence of a predetermined at least one user interaction relating to the component and a predefined user conversion following the predetermined at least one interaction. The at least one user interaction may comprise selecting a component on a web page, or selecting a plurality of components in sequence. A ‘conversion’ (also referred to as “event”) is the successful completion of a ‘goal’ such as but not limited to: selecting a further component; a user completing a form; a user leaving their contact details; a user answering a question or set of questions; a user making contact in the real world, for example by telephone; a user making a purchase now or in the future online or in the real world; signing up for a service; visiting a particular webpage. Each of these conversions may have a event value associated with it. For example, where the event is a sale or potential sale, the event value may be the value of the product or service purchased or to be purchased. The value may thus be calculated based on the event value.

The system associated with and/or implementing the embodiments, may consist of functions performed in serial or in parallel on the same computer or across a network distributed on a plurality of computers. Each of the servers or computers used in the system (each individually referred to as “computer” or collectively as “computers”) may be a general purpose computer or comprise special purpose hardware. Each computer may have a single processor, a multiprocessor, or may be comprised of multiple computers, each of which may comprise a processor or multiprocessor, operably connected over a computer network. Each computer may be controlled by an operating system, for example, Microsoft Windows or Linux.

Each computer may include one or more input and output (I/O) units, network interface, memory system and one or more processing units. The I/O units may be connected to, for example, a monitor, keyboard and mouse. The computer may be connected to the internet via the network interface. The memory system typically includes a hard disk and RAM, but is not limited to such. The memory system may include volatile and non-volatile, removable and non-removable media configured for storage of information, such as RAM, ROM, Erasable Programmable Read Only Memory (EPROM), Electrically Erasable Programmable Read Only Memory (EEPROM), flash memory or other solid state memory, CD-ROM, DVD, or other optical storage, magnetic disk storage, magnetic tape or other magnetic storage devices, or any other medium which can be used to store information which can be accessed.

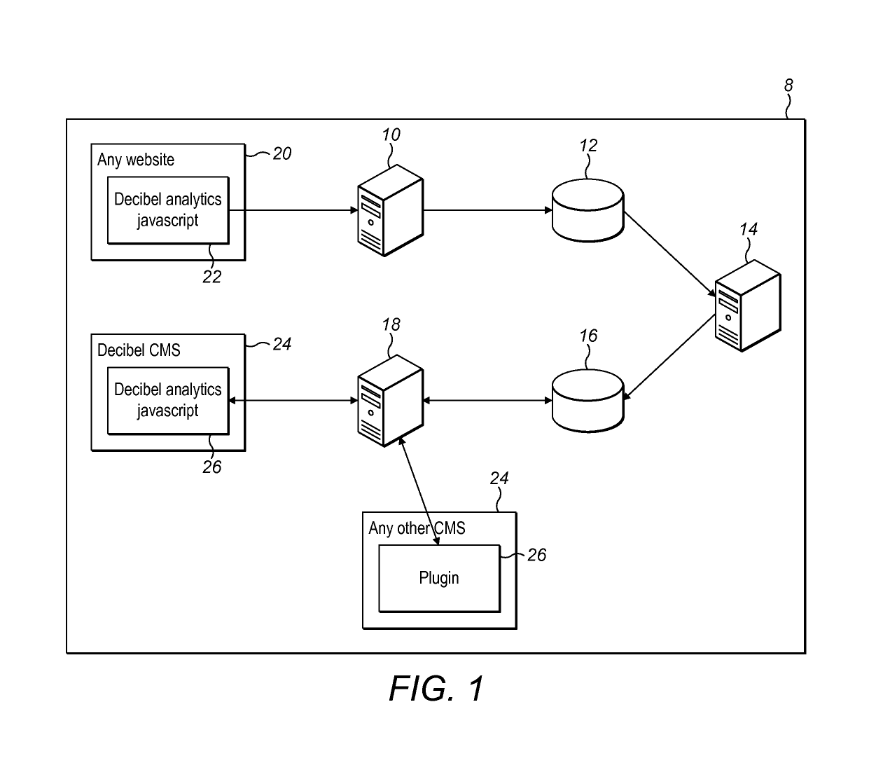

Referring to FIG. 1, an analytics system 8 comprises an analytics server 10, a database, file system or other storage device for storing unprocessed data, referred to as unprocessed data store 12, an analytics process server 14, a database 16 for storing processed data, and an analytics reporting server 18.

The analytics server 10 is configured to receive raw analytics data from suitably configured websites, one such website being indicated at 20. Such websites include predetermined tracking code in the form of javascript or other machine readable code, indicated illustratively at 22. The tracking code is configured to cause to be sent, in response to predetermined user interactions, analytics data to the analytics server 10. The analytics server 10 is configured to save the raw analytics data in the unprocessed data store 16, in which the data is typically only stored temporarily. The analytics server 10 also monitors the unprocessed data store for new entries and analyse the recorded data to gather further information about a session.

The tracking code can be added to any website wishing to use the analytics system 8. The code keeps track of raw analytics data in the form of one, some or all of: the clicks, scrolls, length of visit, html element visibility, list of clicked html elements, page url, title, taxonomy, browser information, referrer, user-agent, language etc and, as mentioned above, sends the analytics data to the analytics server 10 at a preset interval. The raw analytics data is saved as to save in the unprocessed data store 16 for later processing.

The analytics process server 14 is configured to read raw analytics data from the unprocessed data store 16 and process the data, which comprises saving the data in different predetermined tables in the processed data database 20. Processing the data also comprises identifying user system environment properties, such as: an identifier of browser type, an identifier of the operating system, an identifier of a flash version being run, and user location information for example city, region. country, isp, company, etc.

The processed data database 16 stores the processed information about analytics data under the control of the analytics process server 14. Each website owner has its own processed data database 16.

The analytics reporting server 18 is configured to receive requests from the analytics reporting code from a client device indicated at 26 which is provided by the owner/controller of the analytics system 8. The analytics reporting server 18 provides data in response to reporting requests, using the data in the processed data database 16. The analytics reporting server 18 converts the data in XML or JSON format and sends the data back to the relevant reporting code.

The reporting code 26 may send different filter criteria, for example, date, ip, company, search engine, keyword etc. to the analytics reporting server 18 in the request and receives the XML or JSON encoded result, the result being dependent on the criteria. This XML or JSON file is then used to generate reports for display on the website.

Heat map code in the form of Display Object-based Heatmap code, for example JavaScript, can be added to any website, which can then be used to request heatmap information from the analytics reporting server 18. The request can be filtered by date range, ip address, country, search engine, browser etc. The parameters on which the filtering takes place provided at least partially preset, or can be provided in the request.

In response to a request deriving from the heat map code, the analytics reporting server 18 obtains and sends a list of HTML elements along with number of clicks, duration of the element visibility, number of times it appeared on a converted user session, total value of all the sessions where users converted.

By understanding customer's real or potential value, the value of physical areas of a page, types of content, designs, layouts, messages, offers and user journeys can be calculated, which enables a decision, automated or manual, on what to display to maximise the conversion of new or existing users (typically customers) depending on their user type defined by interest, preferences and/or past interactions/conversions. Accordingly, the same website may display differently for different users.

A website may be modular and the components may be modular. The components may be displayed on any device configured to allow browsing, including desktop computers, laptops, notepads, tablets and/or smartphones.

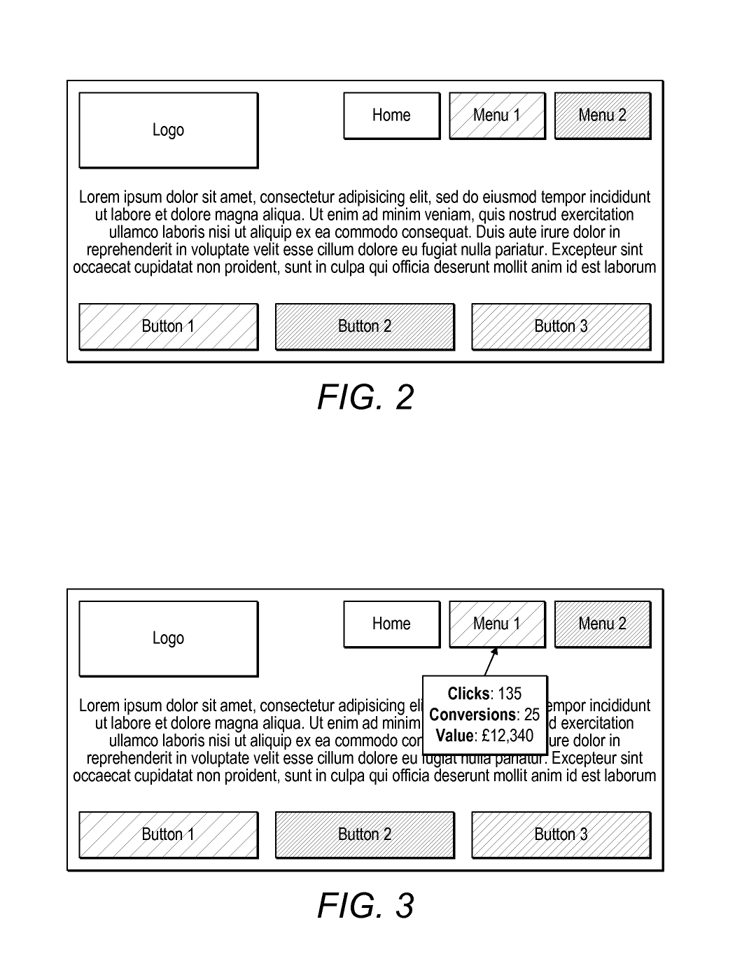

Once the list of element and other relevant information (clicks, total value, duration etc.) is received the analytics reporting server 18 can also calculate a color range from red to green where red is the most valuable or clicked element and green is the least valuable or clicked element. Information on the particular colors to be associate with particular components is also sent to the heat map code. Different colors can be defined as well. In FIGS. 2, 3, 4A and 4B, the different degrees of value are indicated by different patterns.

After calculating the color range, a canvas, e.g. an HTML canvas, is generated with the relevant color and displayed on top of the relevant component, e.g. HTML element. The underlying website beneath the heat map layer will continue to work as normal. In the case of a dynamic website where the components do not have a fixed position the object based heat map changes the canvas layers to reposition on top of appropriate components.

Value may be based on the ‘potential’ value or the ‘resulting’ value of their custom. User interaction data is collected and converted into a value based on their potential and/or actual value, and may be displayed as graphical heat maps within a web page and/or as tabulated data. For example, the heat maps may display the sales value (or potential sales value) that is generated (or potentially generated) from customers as a result of interacting with one or more links, buttons, images, objects or areas within a web page or website.

Referring to FIG. 2, value is shown by overlaying components of the website which were interacted upon by valuable visitors with a pattern indicative of its relative worth amongst all components on the webpage.

The heat map is a visual representation of component value. The maps are displayed in a manner that is independent of the physical resolution of the device on which the data was collected or the device on which the report is viewed, thus removing the limitations of conventional methods that rely on positional information such as x and y coordinates.

Examples of user interactions and events that may be considered to produce value for a web page include:
(i) the user interaction may be selecting a component in the form of a link or selecting in sequence components in the form of a chain of links, and the event (“conversion”) may be completing and submitting a contact form;
(ii) the user interaction may be playing/watching a component in the form of a video advertisement and selecting a link (which may be clicking on the video content), and the event may be making a purchase subsequent to selecting the link.
(iii) the user interactions may be with a component in the form of an online game, and the event may be subsequently registering for a service;
(iv) the user visiting the page as the result of a particular campaign, and subsequently viewing an additional page on the web site or clicking on a particular link or element on the page.

Information about each component, e.g. HTML element, can be viewed by clicking or hovering on the heat map canvas layer, as shown in FIG. 3. In FIG. 3, a value displayed may include the number of clicks and conversions (or events), as well as the actual value of purchase made by visitors who converted after interacting with the selected element.

In embodiments, a browsing window having components is automatically modified, for example the layout of a webpage or website is changed, and values are determined over time periods for different components and/or layouts. By comparison of values for different components and/or layouts, it can be determined which components and/or layout of a page or website are most valuable. The determining can be done automatically or by an administrator. The system can be configured to display the most valuable content, modules of a website and designs, etc, so that the most value is achieved. The comparison can be done using A/B testing scenarios, manual administrator taxonomisation of content, and/or automated machine learning association and grouping of content, modules and designs.

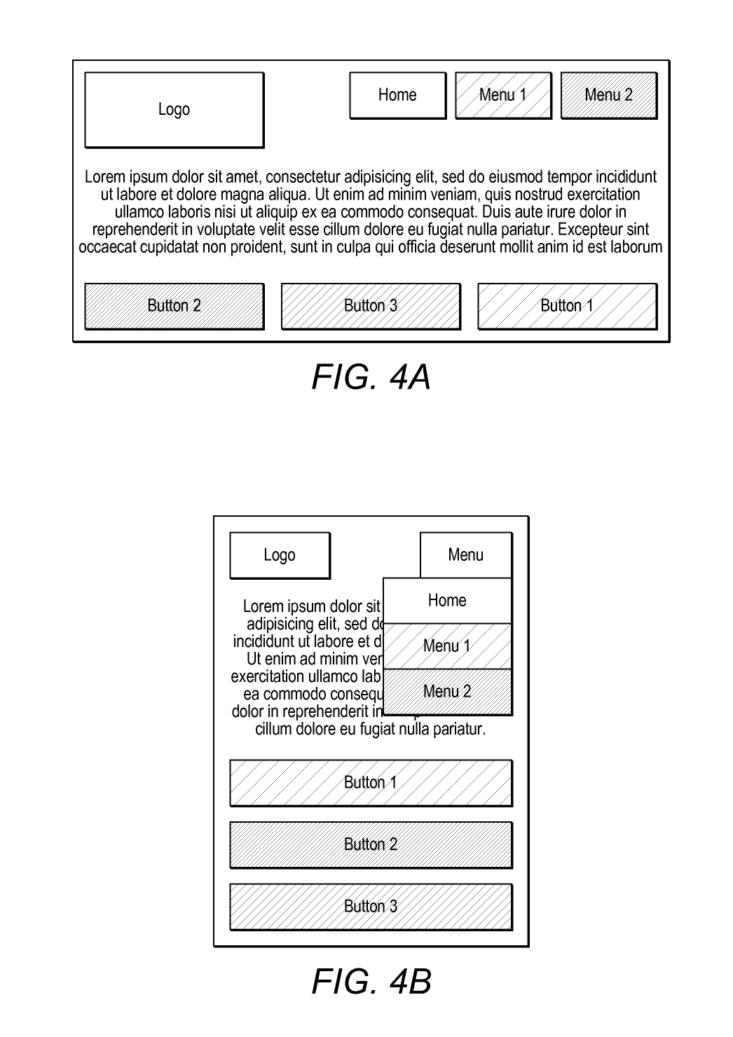

Referring to FIGS. 4A and 4B, the value of specific website components can be displayed while those components are located in different positions. The value heat map may be responsive due to the repositioning of content on the webpage over time using a Content Management System (CMS), content personalisation tool or a content testing tool, as shown in FIG. 4A. Alternatively, the value heat map may be responsive to the device on which the website is being viewed, such as a mobile or tablet device, as shown in FIG. 4B.

In embodiment, the website on which the value of one or more components is determined may be an adaptive website. Such a website may adjust the structure, content, or presentation of information, for example based on model or models user interaction such as may be created using artificial intelligence and statistical methods. The structure, content or presentation of information of the website can be altered so that the website is better suited for the user. In embodiments, adaptive websites be modified in dependence on the determined values of components. Further, interactions with components may be tracked on adaptive websites that appear with different structures, content or containing different presentations of information.

In embodiment, the website on which the value of one or more components is determined may also be built using responsive web design (RWD). Such websites are designed to enable easy reading and navigation with a minimum of resizing, panning, and scrolling across a wide range of devices (from desktop computer monitors to mobile phones). A site designed with RWD adapts the layout to the viewing environment by using fluid, proportion-based grids, flexible images, and CSS3 media queries, an extension of the @media rule. The fluid grid concept calls for page element sizing to be in relative units like percentages, rather than absolute units like pixels or points. Flexible images are also sized in relative units, so as to prevent them from displaying outside their containing element; tracked components may be sized in relative units. Media queries allow the page to use different CSS style rules based on characteristics of the device the site is being displayed on, most commonly the width of the browser. Server-side components (RESS) in conjunction with client side ones such as media queries can produce faster-loading sites for access over cellular networks and also deliver richer functionality/usability. In embodiments, components may be prioritised or dropped, in dependence on determined value of the components.

Where the website is an adaptive website or a website using RWD, the heat map displayed may be responsive to the device on which the website is being viewed, so that areas of the heat map corresponding to particular components are shown respectively overlying those particular components.

A script is added to any website wishing to utilise the functionality described above. The script keeps track of visitor interactions including, but not limited to: (a) clicks and scrolls; (b) length of visit; (c) html element visibility; (d) clicked html elements; (e) page information such as the URL, title and keywords (or taxonomy); (f) browser information such as the user-agent and language; and (g) referrer. This information is sent to web analytics server at a preset interval, as mentioned above. Upon receiving data, the web analytics server processes the data to determine whether the user is a valuable visitor and whether the visitor has provided potential value or actual value to the website owner.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising determining a value indicative of worth of a component, wherein the component is configured for display in an online browsing window, in dependence at least on the occurrence of a predetermined at least one user interaction relating to the component and a predefined event following the predetermined at least one user interaction.

2. The method of claim 1, wherein the predetermined at least one user interaction comprises a predetermined sequence of user interactions.

3. The method of claim 1, further comprising displaying information representative of the value.

4. The method of claim 1, wherein the component occupies one of plurality of possible positions in the online browsing window.

5. The method of claim 1, wherein the value is determined in dependence on the potential value or actual value of the event.

6. The method of claim 1, wherein the event is one of:
(i) selecting a further predetermined component;
(ii) completing and submitting an online form;
(iii) registering for a service;
(iv) purchasing a particular product or service online;
(v) purchasing a product or service from a particular website (optionally a third party website);
(vi) submitting a response to at least one question;
(vii) placing a voice call to a predetermined number.

7. The method of claim 1, wherein an event value is associated with the event, when the value indicative of worth is also determined in dependence on said event value. For example, where the event is a sale or potential sale, the event value may be the value of the product or service purchased or to be purchased.

8. The method of claim 1, wherein the at least one component comprises a hyperlink or selectable component.

9. A method comprising determining a value for each of at least two components contemporaneously displayed in different positions in the online browsing window in accordance with the method of claim 1, and causing information representative of the value for each component to be graphically displayed in a heat map.

10. The method of claim 9, wherein the heat map has a plurality of areas, wherein each area corresponds to a respective one of the components and in each area the determined value for each component is graphically represented.

11. The method of claim 10, wherein the area of the heat map corresponding to a one of the components is approximately of the same size on the display as the area occupied by the one component and is in approximately the same position as the one component.

12. The method of claim 11, wherein the heat map is caused to display to translucently overlie the webpage to provide a graphic representation of the worth of the components on the web page.

13. The method of claim 9, wherein the causing to display a heat map comprises determining a color from a predefined list of colors, wherein the colors correspond to values of the worth of the at least two components.

14. The method of claim 1, further comprising capturing and storing data indicative of the occurrence of the predetermined at least one user interaction and the event that follows the predetermined at least one user interaction, to enable determining of the value.

15. The method of claim 14, further comprising, each time said data is captured and stored, also receiving and recording in the store at least one of the following pieces of information in association with the data:
data indicative of at least one attribute of the system environment of the device on which the web page is accessed;
at least one attribute of the user of the device;
data indicative of scrolls over the component;
data indicative of the length of visit on the webpage;
information on component visibility;
information on content, layout, colors, calls to action displayed (i.e. information on requests for the user to perform to perform a particular act or action) to user;
information on component interaction;
an URL of the web page;
title;
taxonomy of the website and web page;
a identifier of the browser used to access the web page;
an identifier of a referrer;
an identifier of a non-computer language(s) used in the website.

16. A method comprising:
determining a value for a component in accordance with the method of claim 1;
rearranging the position of the component in the window or modifying the component;
determining a value for the rearranged or modified component in accordance with the method of claim 1;
displaying the component or the rearranged or modified component in dependence on which is higher of the values.

17. The method of claim 16, further comprising, prior to the step of displaying, comparing, by the processing apparatus, the values, wherein the display of the component or the rearranged or modified component is done based on a result of the comparison.

18. The method of claim 16, wherein the rearranging or modifying is performed automatically by the processing apparatus.

19. A computer program product stored on a computer readable storage medium and comprising executable instructions, which, when executed by processing apparatus, causes determining of a value indicative of worth of a component, wherein the component is configured for display in an online browsing window, in dependence at least on the occurrence of a predetermined at least one user interaction relating to the component and a predefined event following the predetermined at least one user interaction.

20. Apparatus comprising:
at least one processor;
at least one memory including computer program code, the at least one memory and the computer program code, with the at least one processor, being configured to cause the apparatus at least to perform determining of a value indicative of worth of a component, wherein the component is configured for display in an online browsing window, in dependence at least on the occurrence of a predetermined at least one user interaction relating to the component and a predefined event following the predetermined at least one user interaction.
